(19) United States
(12) Patent Application Publication
(10) Pub. No.: US 2019/0062119 A1
(43) Pub. Date: Feb. 28, 2019

(54) ELEVATOR HIDDEN-COMPONENT INSPECTION SYSTEMS

(71) Applicant: Otis Elevator Company, Farmington, CT (US)

(72) Inventor: Aurelien Fauconnet, Isdes (FR)

(21) Appl. No.: 16/111,576

(22) Filed: Aug. 24, 2018

(30) Foreign Application Priority Data
Aug. 30, 2017 (EP) 17306111.0

(51) Int. Cl. B66B 7/12; B66B 5/00; B66B 1/36

(52) U.S. Cl. CPC B66B 7/1238; B66B 5/0012; B66B 1/365; B66B 5/0031

(57) ABSTRACT

Elevator inspection systems having an elevator car moveable within an elevator shaft, a camera mounted to the elevator car and operable to inspect components of an elevator system, at least one hidden-component located within the elevator shaft, wherein the at least one hidden-component is a component of the elevator system that is located such that the camera cannot achieve direct, line-of-sight inspection of the hidden-component, and at least one mirror fixedly mounted to the elevator shaft and positioned such that when the camera views the at least one mirror, the camera can capture a reflected image of the at least one hidden-component.

### BACKGROUND

The subject matter disclosed herein generally relates to elevator systems and, more particularly, elevator hidden-component inspection systems.

Elevator systems include numerous components located within elevator shafts that may require inspection and/or maintenance. To perform such inspections, a technician or other personnel will typically enter the elevator shaft and visually inspect the components. Such visual inspection may require the technician to be located below or above (e.g., on top of) an elevator car within the elevator shaft. It may be advantageous to improve inspection capabilities and/or safety of inspection for elevator systems.

### SUMMARY

According to some embodiments, elevator inspection systems are disclosed herein. The elevator inspection systems include an elevator car moveable within an elevator shaft, a camera mounted to the elevator car and operable to inspect components of an elevator system, at least one hidden-component located within the elevator shaft, wherein the at least one hidden-component is a component of the elevator system that is located such that the camera cannot achieve direct, line-of-sight inspection of the hidden-component, and at least one mirror fixedly mounted to the elevator shaft and positioned such that when the camera views the at least one mirror, the camera can capture a reflected image of the at least one hidden-component.

In addition to one or more of the features described herein, or as an alternative, further embodiments of the elevator inspection systems may include that the at least one hidden-component is housed within an elevator car upright.

In addition to one or more of the features described herein, or as an alternative, further embodiments of the elevator inspection systems may include that the at least one hidden-component is at least one of an elevator car guidance component or an elevator car safety component.

In addition to one or more of the features described herein, or as an alternative, further embodiments of the elevator inspection systems may include that the at least one hidden-component is at least one of a counterweight guidance component or a counterweight safety component.

In addition to one or more of the features described herein, or as an alternative, further embodiments of the elevator inspection systems may include that the camera is mounted to a top of the elevator car.

In addition to one or more of the features described herein, or as an alternative, further embodiments of the elevator inspection systems may include that the camera is located on a bottom of the elevator car.

In addition to one or more of the features described herein, or as an alternative, further embodiments of the elevator inspection systems may include that the camera is at least one of rotatable or pivotable.

In addition to one or more of the features described herein, or as an alternative, further embodiments of the elevator inspection systems may include that the at least one mirror comprises a first mirror located at a first position within the elevator shaft and a second mirror located at a second position within the elevator shaft, wherein the first and second positions are different.

In addition to one or more of the features described herein, or as an alternative, further embodiments of the elevator inspection systems may include that the first mirror is arranged to enable inspection of a hidden-component associated with movement of the elevator car.

In addition to one or more of the features described herein, or as an alternative, further embodiments of the elevator inspection systems may include that the second mirror is arranged to enable inspection of a hidden-component associated with movement of an elevator counterweight.

According to some embodiments, methods for inspecting hidden-components using the elevator inspection system of any of the preceding embodiments are provided. The methods include moving the elevator car to a first position, wherein a first mirror of the at least one mirror is located proximate the first position, aiming the camera at the first mirror to capture an image of a first hidden-component of the at least one hidden component, and performing an inspection of the first hidden-component.

In addition to one or more of the features described herein, or as an alternative, further embodiments of the methods may include moving the elevator car to a second position, wherein a second mirror of the at least one mirror is located proximate the second position, aiming the camera at the second mirror to capture an image of a second hidden-component of the at least one hidden component, and performing an inspection of the second hidden-component.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1 is a schematic illustration of an elevator system that may employ various embodiments of the present disclosure;

FIG. 2 is a schematic illustration of an elevator component inspection system;

FIG. 3 is a schematic illustration of an elevator hidden-component inspection system in accordance with an embodiment of the present disclosure;

FIG. 4A is a schematic illustration of an elevator hidden-component inspection system in accordance with an embodiment of the present disclosure;

FIG. 4B is an enlarged illustration of a reflected image of the elevator hidden-component inspection system of FIG. 4A;

FIG. 5 is a schematic illustration of an elevator hidden-component inspection system in accordance with an embodiment of the present disclosure;

FIG. 6 is a schematic illustration of an elevator hidden-component inspection system in accordance with an embodiment of the present disclosure; and

FIG. 7 is a flow process for performing an inspection of a hidden-component in accordance with an embodiment of the present disclosure.

### DETAILED DESCRIPTION

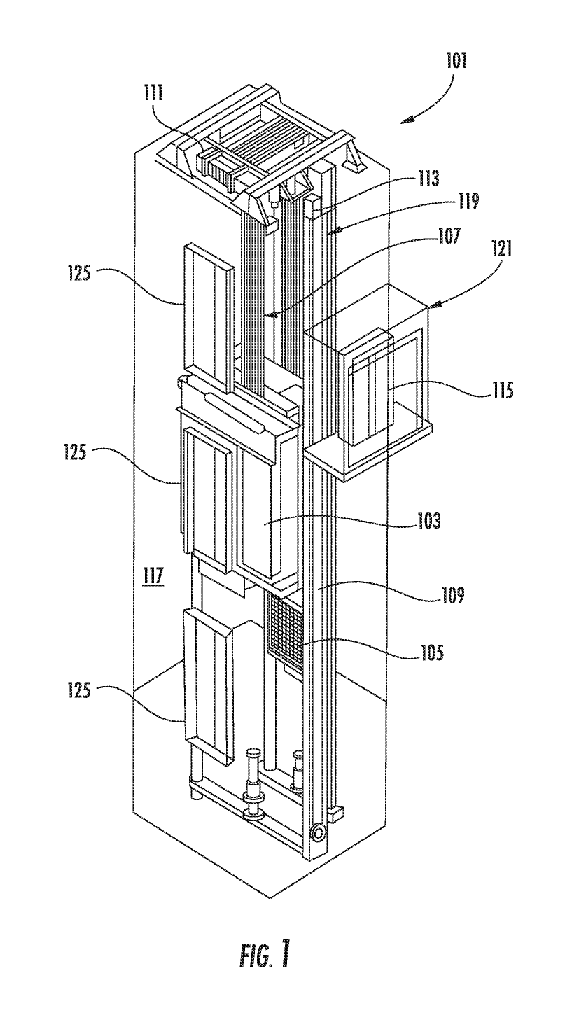

FIG. 1 is a perspective view of an elevator system 101 including an elevator car 103, a counterweight 105, a roping 107, a guide rail 109, a machine 111, a position encoder 113, and a controller 115. The elevator car 103 and counterweight 105 are connected to each other by the roping 107. The roping 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft 117 and along the guide rail 109.

The roping 107 engages the machine 111, which is part of an overhead structure of the elevator system 101. The machine 111 is configured to control movement between the elevator car 103 and the counterweight 105. The position encoder 113 may be mounted on an upper sheave of a speed-governor system 119 and may be configured to provide position signals related to a position of the elevator car 103 within the elevator shaft 117. In other embodiments, the position encoder 113 may be directly mounted to a moving component of the machine 111, or may be located in other positions and/or configurations as known in the art.

The controller 115 is located, as shown, in a controller room 121 of the elevator shaft 117 and is configured to control the operation of the elevator system 101, and particularly the elevator car 103. For example, the controller 115 may provide drive signals to the machine 111 to control the acceleration, deceleration, leveling, stopping, etc. of the elevator car 103. The controller 115 may also be configured to receive position signals from the position encoder 113. When moving up or down within the elevator shaft 117 along guide rail 109, the elevator car 103 may stop at one or more landings 125 as controlled by the controller 115. Although shown in a controller room 121, those of skill in the art will appreciate that the controller 115 can be located and/or configured in other locations or positions within the elevator system 101.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor.

Although shown and described with a roping system, elevator systems that employ other methods and mechanisms of moving an elevator car within an elevator shaft may employ embodiments of the present disclosure. FIG. 1 is merely a non-limiting example presented for illustrative and explanatory purposes.

At times, various of the components of the elevator system may require inspection and/or maintenance to be performed thereon. For some of the components, visual inspection may be simple, with the component exposed and readily visible. However, other components may be hidden from easy inspection. Such hidden-components can include, but are not limited to, car guidance components, guide rail elements, car safety elements, car upright elements, counterweight guidance, counterweight safety, etc. These hidden-components may not be visible directly because of intervening structures, such as guide rails.

Various embodiments of the present disclosure are directed to cameras installed within the elevator shaft, and in some embodiments to the top or bottom of an elevator car. The cameras can be used to perform automated and/or remote visual inspection of components within the elevator shaft, without requiring a technician to physically enter the elevator shaft to perform such inspection. However, even using cameras, there may be some components that are not viewable by the camera, i.e., there may be an obstruction (e.g., the guide rail) that prevents the components from being visually inspected.

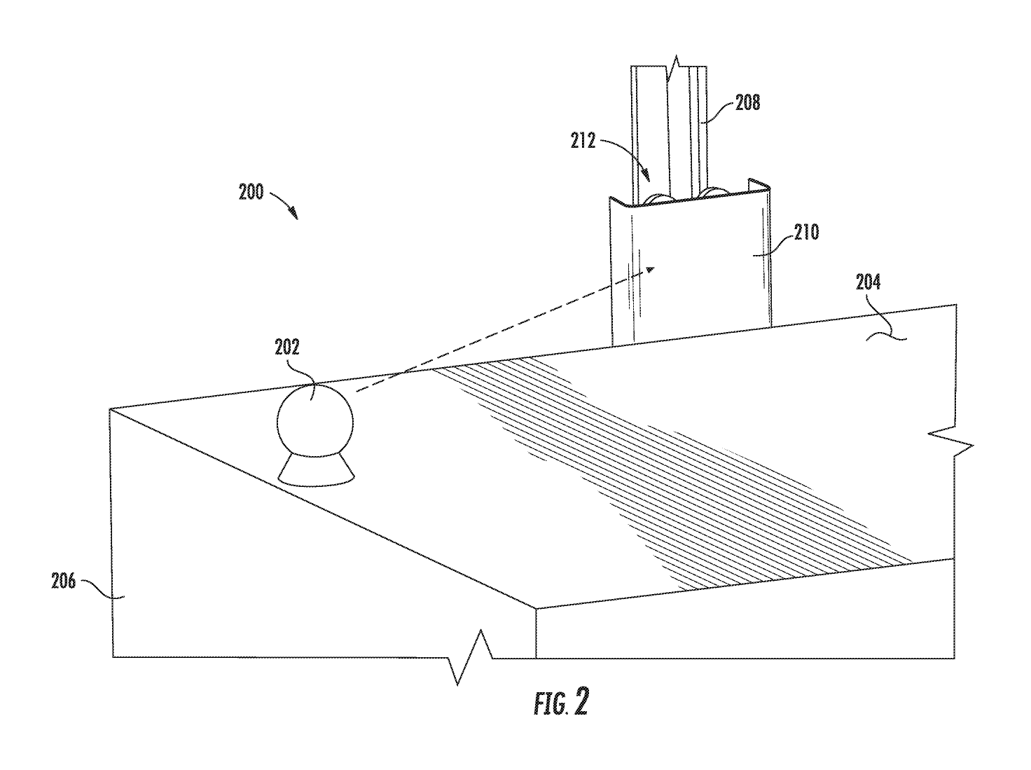

For example, turning to FIG. 2, an inspection system 200 having a camera 202 installed on a top 204 of an elevator car 206 is shown. The camera 202 can be arranged to perform visual inspection of various components of an elevator system that are located within an elevator shaft, including, but not limited to, roping, machines, wiring, guide rails, counterweights, etc. For example, as shown, the camera 202 can be used to inspect a guiderail 208 along which the elevator car 206 may move. The camera 202 can also be used to inspect a portion of an elevator car upright 210. However, as shown, the elevator car upright 210 blocks or obstructs line-of-sight from the camera 202 to one or more hidden-components 212 that are housed within the elevator car upright 210. The hidden-components 212, in this illustration, can include safety devices, guide shoes and/or other guide rail engagement elements, etc. that are housed within obstructing structures, such as the elevator car upright 210.

Accordingly, embodiments of the present disclosure are directed to inspection systems that incorporate one or more cameras located within an elevator shaft and one or more mirrors arranged to enable inspection of hidden-components. Hidden-components, as defined herein, are components of an elevator system that are not directly visible or are completely hidden or obstructed from inspection by a camera located within the elevator shaft. Stated another way, hidden-components are components of the elevator system for which a direct line-of-sight does not exist from an inspection camera to the specific component.

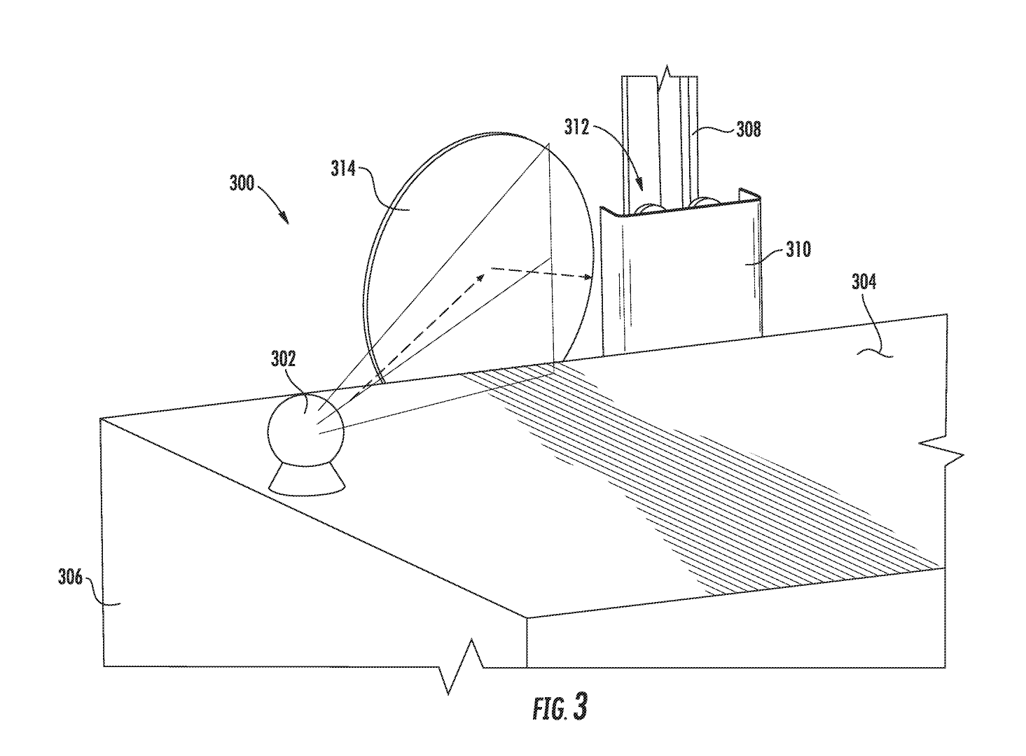

For example, turning to FIG. 3, an elevator hidden-component inspection system 300 having a camera 302 installed on a top 304 of an elevator car 306 is shown. The camera 302 can be arranged to perform visual inspection of various components of an elevator system that are located within an elevator shaft, including, but not limited to, roping, machines, wiring, guide rails, counterweights, etc. The elevator hidden-component inspection system 300 also includes a mirror 314 for enabling inspection of hidden-components 312 that are obstructed from direct line-of-sight by an elevator car upright 310 and/or a guide rail 308. Similar to the arrangement above, the hidden-components 312, in this illustration, can include elevator car guidance components, elevator car safety components, safety devices, guide shoes and/or other guide rail engagement elements, etc. that are housed within obstructing structures, such as the elevator car upright 310.

As will be apparent from FIG. 3, the elevator hidden-component inspection system includes a single camera 302 that is located on the top 304 of the elevator car 306. The camera 302 can be an adjustable camera that can rotate and/or pivot, but is located at a fixed position on the top 304 of the elevator car 306. In some embodiments, the camera may be a low-light or infrared camera which may enable the reduction of components within the elevator shaft (e.g., lighting within the elevator shaft proximate the location of hidden-components). In some embodiments, the camera 302 can be equipped with lighting (e.g., LEDs) located around an aperture/lens of the camera to provide directed lighting and to improve imaging of hidden-components 312, as will be appreciated by those of skill in the art.

With the camera 302 being mounted to a fixed position on the elevator car 306, the camera 302 is moveable within an elevator shaft to enable imaging of different components within the elevator system. During an inspection procedure, the elevator car 306 can be moved to a specific, predetermined position such that the camera 302 can be operated to view a reflected image in the mirror 314 and thus enable inspection of the hidden-components 312. That is, the mirror 314 can be fixed in specific locations within the elevator shaft or directly on the elevator car 306, and the camera 302 can be moved to the appropriate location within the elevator shaft to perform an inspection of a hidden-component 312.

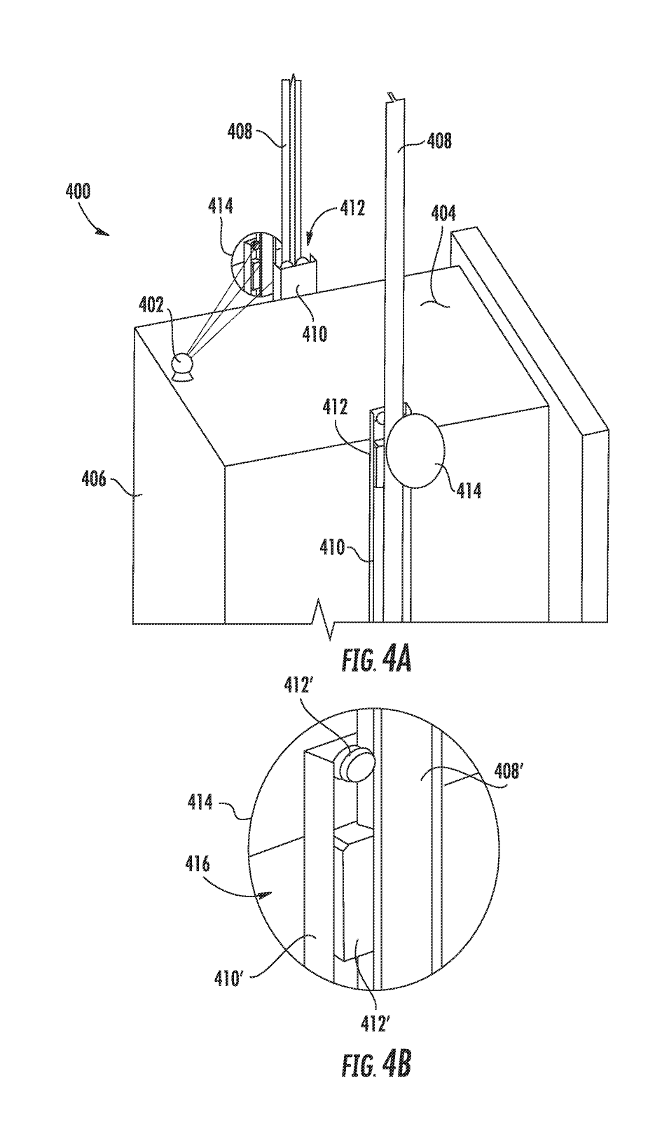

Turning now to FIGS. 4A-4B, a schematic illustration of an elevator hidden-component inspection system 400 in accordance with an embodiment of the present disclosure is shown. FIG. 4B illustrates an image that may be reflected in a mirror 414 and captured by a camera 402 of the elevator hidden-component inspection system 400. As shown, the elevator hidden-component inspection system 400 includes the camera 402 installed on a top 404 of an elevator car 406. The camera 402 is arranged to perform visual inspection of hidden-components 412 of an elevator system. The hidden-components 412 shown in FIG. 4A are obstructed from view of the camera 402 by an elevator car upright 410. As shown, however, the elevator hidden-component inspection system 400 includes a mirror 414 for enabling inspection of the hidden-components 412. Similar to the arrangements above, the hidden-components 412, in this illustration, can include safety devices, guide shoes and/or other guide rail engagement elements, etc. that are housed within obstructing structures, such as the elevator car upright 410.

As shown in FIG. 4A, the elevator car 406 is positioned between, and moves along, two guide rails 408. Each of the guide rails 408 is engaged by one or more hidden-components 412 that are housed within respective elevator car uprights 410. The camera 402 is located at a fixed position on the top 404 of the elevator car 406. Although the camera 402 can observe directly certain components of the elevator system, the camera 402 does not have direct line-of-sight visibility to the hidden-components 412. Accordingly, to enable the camera 402 to capture images and/or video of the hidden-components 412, mirrors 414 are positioned within an elevator shaft (e.g., mounted to a wall of the shaft) at predetermined locations. The elevator car 406 can be moved to the predetermined locations and thus enable imaging of a reflection of the hidden-components 412 in the mirrors 414. As shown, a single camera can view a single mirror 414 at a time, but the camera 402 can be rotated from one mirror 414 to another mirror 414 to enable imaging of multiple, different hidden-components 412.

As shown in FIG. 4B, a reflected image 416 that appears within one of the mirrors 414 is shown. The reflected image 416 includes a reflection of the hidden-components 412 and other structure proximate thereto. For example, as shown, a reflected image of the guide rail 408′, the elevator car uprights 410′, and the hidden-components 412′ is observable within the mirror 414. Accordingly, elements or components of elevator systems that may not be readily visible for inspection can be made visible through use of the elevator hidden-component inspection system 400 shown and described herein.

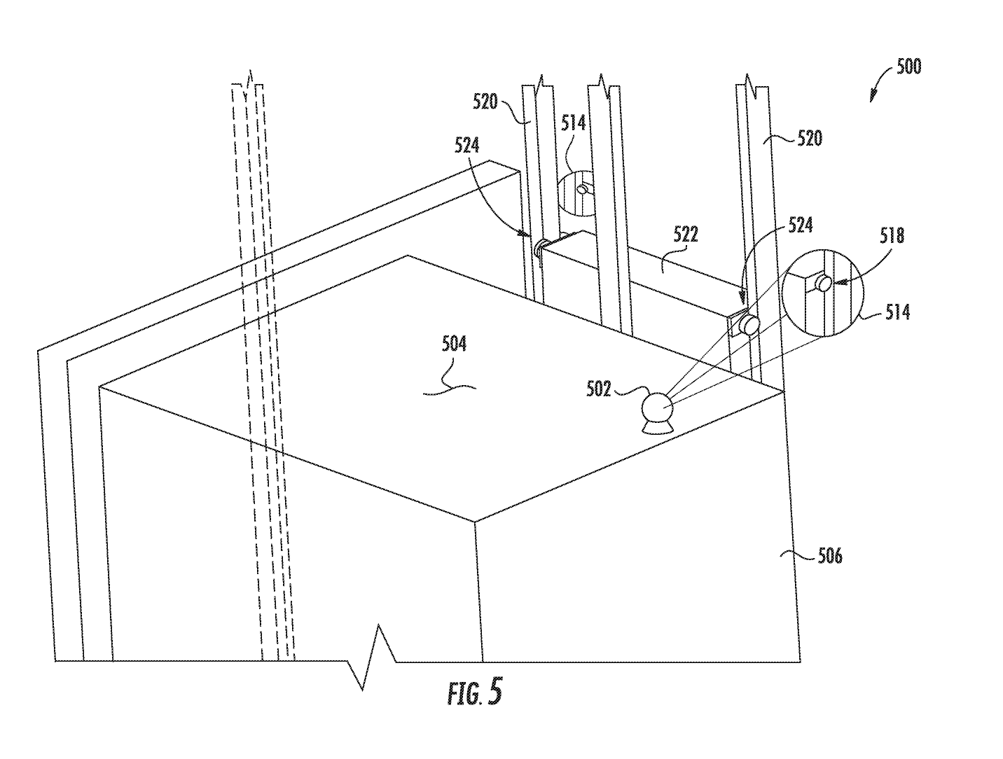

Turning now to FIG. 5, another arrangement of an elevator hidden-component inspection system 500 in accordance with an embodiment of the present disclosure is schematically shown. Similar to the other embodiments described herein, the elevator hidden-component inspection system 500 includes a camera 502 installed at a fixed location on a top 504 of an elevator car 506. The camera 502 is arranged to perform visual inspection of various components of an elevator system that are located within an elevator shaft, as described above. The elevator hidden-component inspection system 500 also includes mirrors 514 for enabling inspection of hidden-components 518 that are obstructed from direct line-of-sight by a counterweight rail 520. In this embodiment, the hidden-components 518 are associated with a counterweight 522. The counterweight 522 is movable along the counterweight rails 520 using one or more counterweight guidance elements 524. As shown, only a portion of the counterweight guidance elements 524 are directly visible to the camera 502 (i.e., direct line-of-sight) and a portion of the counterweight guidance elements 524 are the hidden-components 518. The hidden-components 518 associated with counterweight operation can include counterweight guidance components, counterweight safety components, etc.

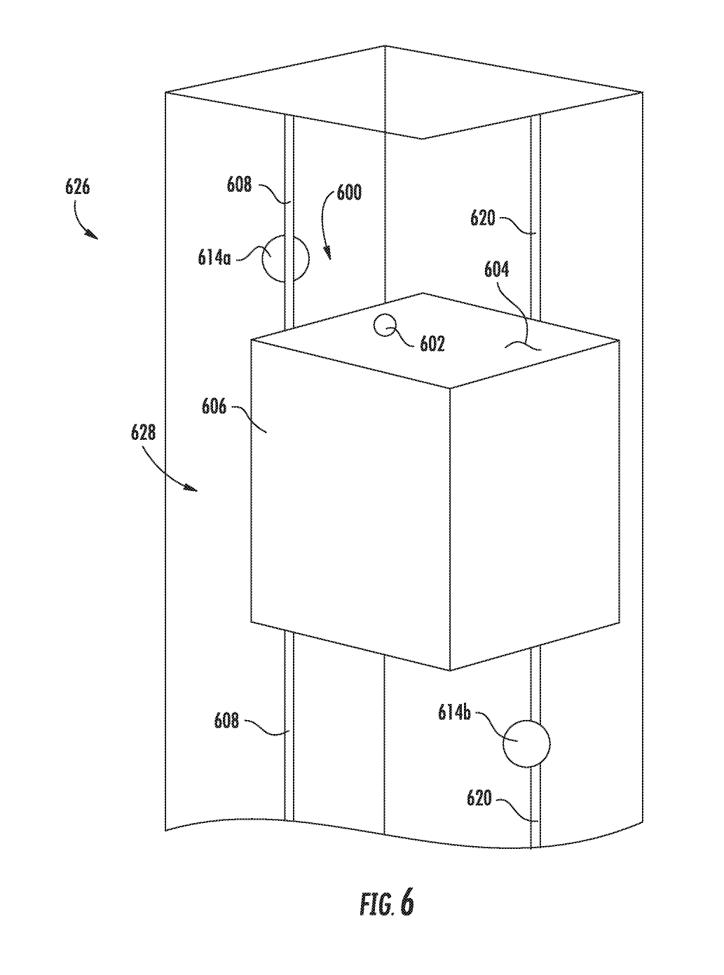

Turning now to FIG. 6, a schematic illustration of an elevator system 626 in accordance with an embodiment of the present disclosure is shown. The elevator system 626 includes an elevator car 606 movable within an elevator shaft 628. The elevator car 606 is operably connected to a counterweight (not shown). The elevator car 606 is movable along guide rails 608 and the counterweight is movable along a counterweight guide rail 620. Both the elevator car 606 and the counterweight may include one or more hidden-components located thereon, such as shown and described above.

To enable inspection of the hidden-components, the elevator system 626 includes an elevator hidden-component inspection system 600. The elevator hidden-component inspection system 600 includes a camera 602 mounted at a fixed location on a top 604 of the elevator car 606. The elevator hidden-component inspection system 600 also includes a first mirror 614a and a second mirror 614b located at different positioned within the elevator shaft 628. For example, the first mirror 614a may be located at a first position (e.g., toward a top of the elevator shaft 628) and arranged proximate the guide rail 608 of the elevator car 606 to enable inspection of hidden-components that are blocked by the guide rail 608 and/or by an elevator car upright, as shown and described above. The second mirror 614b may be positioned at a second location (e.g., toward the bottom of the elevator shaft 628) and arranged proximate the counterweight guide rail 620 to enable inspection of hidden-components that are blocked or obstructed from view by the counterweight guide rail 620. The camera 602 may be rotatable or pivotable such that the camera 602 can have direct line-of-sight to the first mirror 614a and the second mirror 614b when located at a respective position within the elevator shaft 628.

Although shown and described herein with the camera of the elevator hidden-component inspection systems located on a top of the elevator car, those of skill in the art will appreciate that other arrangements are possible without departing from the scope of the present disclosure. For example, in some embodiments, the camera may be mounted or fixed to a bottom of the elevator car. In other embodiments, the camera may be mounted or fixed to a side wall (or frame) of the elevator car. Thus, the location of the camera is not to be limiting. Further, although shown with a single mirror located proximate each hidden-component, in some embodiments, multiple mirrors may be positioned relative to a hidden-component to enable different viewing angles and/or viewing of different sides/angles of the hidden-component.

In some embodiments, the elevator hidden-component inspection systems described herein can be automated. For example, the elevator hidden-component inspection systems may be integrated with or part of an electronic elevator hidden-component inspection system. The electronic elevator hidden-component inspection system can enable automation by capturing images of components and hidden-components of the elevator system, and process such images to determine if any maintenance should be performed. In such embodiments, the elevator hidden-component inspection system can automatically control operation of the elevator car and thus force the elevator car to predetermined positions to enable inspection of the hidden-components by aligning or positioning the camera relative to a mirror to observe the hidden-components.

Although described herein with respect to hidden-components that are obstructed by elevator car uprights and/or guide rails, those of skill in the art will appreciate that the hidden-components may be any structure, element, component, part of a structure/component/element, etc. that is obstructed from direct line-of-sight with a camera mounted in a fixed location to an elevator car. Non-limiting examples of hidden-components include, but are not limited to, elevator car safety elements located within elevator car uprights, elevator car guidance elements located within elevator car uprights, counterweight safety and guidance systems obstructed by guide rails and/or the counterweight itself, car positioning systems (e.g., head and tape) that may be obstructed by the elevator car itself, elevator car safety blocks, guide shoes, etc.

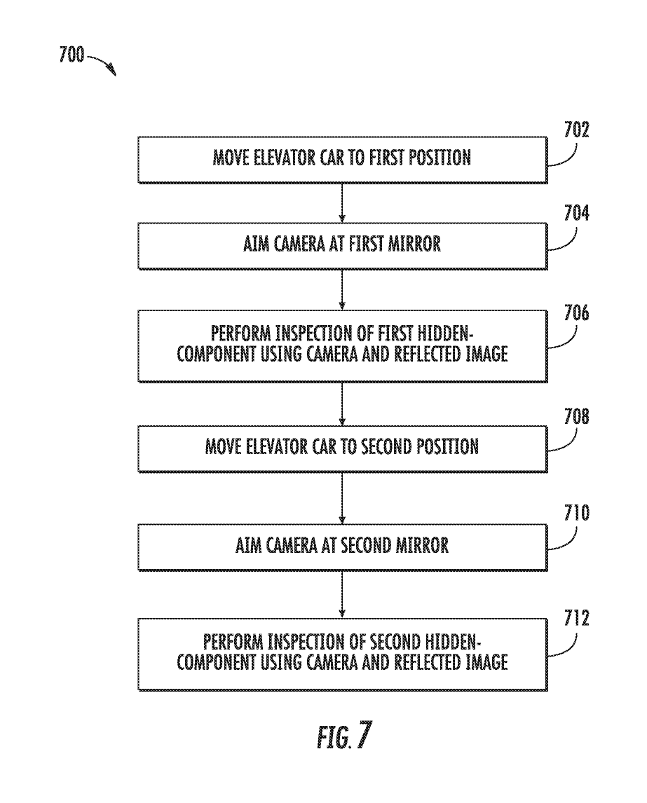

Turning now to FIG. 7, a flow process 700 for performing an inspection operation of an elevator system is shown. The flow process 700 may be employed with various embodiments described herein and/or variations thereon. The flow process 700 is performed using, at least, a fixed camera located on an exterior surface of an elevator car and at least one mirror mounted within an elevator shaft and positioned to enable visual inspection of a hidden-component.

The flow process 700 can be executed using a control unit of an elevator system. The control unit can be a computer or other electronic device that can send commands to and receive data from the camera of the elevator hidden-component inspection system. In some embodiments, the control unit can receive output from the camera (e.g., images, video, etc.). A communication connection between the camera and the control unit can be a physical line or wire or can be a wireless communication connection, as will be appreciated by those of skill in the art. In some embodiments, the control unit can be part of an elevator controller or other electronics associated with other parts or components of the elevator system. Further, in some embodiments, the control unit may be located remote from the elevator car or even remote from the elevator shaft. Moreover, in some embodiments, the control unit may be part of a general purpose computer that is configured to enable maintenance, inspection, and/or monitoring of the elevator system.

At block 702, an elevator car with a fixed camera can be moved to a first position within the elevator shaft.

At block 704, the camera is controlled (e.g., rotated, pivoted, etc.) to aim the camera at a first mirror located at the first position.

At block 706, an inspection of a first hidden-component is performed with the camera receiving a reflected image of the first hidden-component through the mirror. The inspection can include visual inspection that is automated, comparing known “good” operational state images against the captured images. In other embodiments, the captured images can be provided to a technician or other personnel to perform a manual inspection of the images and thus determine if maintenance may be required on the hidden component.

At block 708, the elevator car is moved to a second position within the elevator shaft.

At block 710, the camera is controlled (e.g., rotated, pivoted, etc.) to aim the camera at a second mirror located at the second position.

At block 712, an inspection of a second hidden-component is performed with the camera receiving a reflected image of the second hidden-component through the mirror.

The flow process 700 can be repeated any number of times for any number of hidden-components. In some embodiments, only one mirror may be used for inspection of one or more hidden-components, depending on the arrangement of the elevator system.

Advantageously, embodiments provided herein can improve camera use for inspection of components of elevator systems. For example, advantageously, use of a single camera mounted in a fixed location on an elevator car with one or more mirrors mounted at fixed locations within an elevator shaft can reduce the number of typically required cameras for the same scope of inspections. Further, advantageously, control elements may be simplified by reducing the number of cameras to one.

Those of skill in the art will appreciate that various example embodiments are shown and described herein, each having certain features in the particular embodiments, but the present disclosure is not thus limited. That is, features of the various embodiments can be exchanged, altered, or otherwise combined in different combinations without departing from the scope of the present disclosure.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments.

Accordingly, the present disclosure is not to be seen as limited by the foregoing description, but is only limited by the scope of the appended claims.

1. An elevator inspection system comprising:
an elevator car moveable within an elevator shaft;
a camera mounted to the elevator car and operable to inspect components of an elevator system;
at least one hidden-component located within the elevator shaft, wherein the at least one hidden-component is a component of the elevator system that is located such that the camera cannot achieve direct, line-of-sight inspection of the hidden-component; and
at least one mirror fixedly mounted to the elevator shaft and positioned such that when the camera views the at least one mirror, the camera can capture a reflected image of the at least one hidden-component.

2. The elevator inspection system of claim 1, wherein the at least one hidden-component is housed within an elevator car upright.

3. The elevator inspection system of claim 1, wherein the at least one hidden-component is at least one of an elevator car guidance component or an elevator car safety component.

4. The elevator inspection system of claim 1, wherein the at least one hidden-component is at least one of a counterweight guidance component or a counterweight safety component.

5. The elevator inspection system of claim 1, wherein the camera is mounted to a top of the elevator car.

6. The elevator inspection system of claim 1, wherein the camera is located on a bottom of the elevator car.

7. The elevator inspection system of claim 1, wherein the camera is at least one of rotatable or pivotable.

8. The elevator inspection system of claim 1, wherein the at least one mirror comprises a first mirror located at a first position within the elevator shaft and a second mirror located at a second position within the elevator shaft, wherein the first and second positions are different.

9. The elevator inspection system of claim 8, wherein the first mirror is arranged to enable inspection of a hidden-component associated with movement of the elevator car.

10. The elevator system of claim 8, wherein the second mirror is arranged to enable inspection of a hidden-component associated with movement of an elevator counterweight.

11. A method for inspecting hidden-components using the elevator inspection system comprising an elevator car moveable within an elevator shaft, a camera mounted to the elevator car and operable to inspect components of an elevator system, at least one hidden-component located within the elevator shaft, wherein the at least one hidden-component is a component of the elevator system that is located such that the camera cannot achieve direct, line-of-sight inspection of the hidden-component, and at least one mirror fixedly mounted to the elevator shaft and positioned such that when the camera views the at least one mirror, the camera can capture a reflected image of the at least one hidden-component, the method comprising:
moving the elevator car to a first position, wherein a first mirror of the at least one mirror is located proximate the first position;
aiming the camera at the first mirror to capture an image of a first hidden-component of the at least one hidden component; and
performing an inspection of the first hidden-component.

12. The method of claim 11, further comprising:
moving the elevator car to a second position, wherein a second mirror of the at least one mirror is located proximate the second position;
aiming the camera at the second mirror to capture an image of a second hidden-component of the at least one hidden component; and
performing an inspection of the second hidden-component.

13. The method of claim 11, wherein the at least one hidden-component is housed within an elevator car upright.

14. The method of claim 11, wherein the at least one hidden-component is at least one of an elevator car guidance component or an elevator car safety component.

15. The method of claim 11, wherein the at least one hidden-component is at least one of a counterweight guidance component or a counterweight safety component.

16. The method of claim 11, wherein the camera is mounted to a top of the elevator car.

17. The method of claim 11, wherein the camera is located on a bottom of the elevator car.

18. The method of claim 11, wherein the camera is at least one of rotatable and pivotable.

19. The method of claim 11, wherein the at least one mirror comprises a first mirror located at a first position within the elevator shaft and a second mirror located at a second position within the elevator shaft, wherein the first and second positions are different.
